(19) United States
(12) Patent Application Publication
(10) Pub. No.: US 2005/0145715 A1
(43) Pub. Date: Jul. 7, 2005

(54) Drop ejector for ejecting discrete drops of liquid

(76) Inventors: John M. Koegler III, Corvallis, OR (US); Kenneth E. Trueba, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/750,260

(22) Filed: Dec. 31, 2003

(51) Int. Cl. B05C 1/00

(52) U.S. Cl. 239/135

(57) ABSTRACT

A drop ejector for ejecting discrete drops of liquid is disclosed. The drop ejector includes a plurality of firing chambers, and each firing chamber has an energy dissipation device. Each firing chamber is associated with a fluid feed slot configured to supply liquid to the firing chamber. A constricted inlet is positioned between the firing chamber and the fluid feed slot, through which liquid is drawn into the firing chamber from the fluid feed slot.

### BACKGROUND

Drop ejectors are known devices used in ink jet printers to eject discrete drops of liquid ink onto a medium, such as paper, adapted to receive the liquid ink. An exemplary drop ejector for ejecting discrete drops of liquid ink is described in U.S. Pat. No. 6,162,589 to Chen.

As described in U.S. patent application Ser. No. 10/086,002 commonly assigned to the owner of this application, it has been suggested to use liquid ink drop ejectors as a central component in an improved fuel injector for ejecting discrete drops of liquid fuel to create a combustible vapor for an internal combustion engine. The use of a drop ejector allows more precise control of the air/fuel mixture provided to the internal combustion engine as compared to conventional fuel injectors.

However, liquid fuel, such as gasoline or diesel fuel, has different physical properties, including a lower viscosity, than the liquid ink for which drop ejectors have historically been used. As a result, various problems exist in attempting to use known liquid ink drop ejectors to dispense liquid fuel, as well as other lower viscosity liquids. For example, the inventors have recognized that when known drop ejectors are used to dispense relatively low viscosity liquids, problems exist with “puddling” and “bubble trapping”, which are all described in more detail hereinafter.

The embodiments described in this application were developed in light of and to address these and other problems associated with using drop ejectors to eject discrete drops of relatively low viscosity liquids.

### BRIEF DESCRIPTION OF THE DRAWINGS

FIG. 1 is a perspective view of an exemplary embodiment of a fuel delivery system.

FIG. 2 is a partially cut-away view of the fuel delivery system of FIG. 1.

FIG. 3 is a perspective view of an exemplary embodiment of a liquid drop ejector.

FIG. 4 is a close up view of exemplary firing chambers used in the exemplary embodiment of the liquid fuel drop ejector of FIG. 3.

FIG. 5 is a side, cross-sectional view of an exemplary firing chamber shown in FIG. 3.

FIG. 6 is a top view of the exemplary firing chamber shown in FIG. 5.

### DETAILED DESCRIPTION

An embodiment of an improved drop ejector for ejecting discrete drops of liquid, such as liquid fuel, is described. The improved drop ejector is described, in one exemplary embodiment, as used in a fuel injector that generates a combustible vapor from the discrete drops of fuel ejected from the drop ejector. The drop ejector includes a plurality of firing chambers from which the liquid drops are ejected. Liquid is delivered to each of the firing chambers through a plurality of fluid feed slots, wherein each firing chamber is associated with at least one feed slot. A constricted inlet is located between each firing chamber and the corresponding feed slot. Liquid fuel is drawn into each firing chamber from its corresponding feed slot through its constricted inlet. Each inlet is narrower than the fluid feed slot and the firing chamber (i.e., the inlet is “constricted”) so as to provide improved control of the liquid fuel being delivered to the firing chamber and the fuel drops being ejected from the firing chambers. The constricted inlet prevents or reduces “puddling” and “bubble trapping” problems, which are described in more detail hereinafter, as well as others.

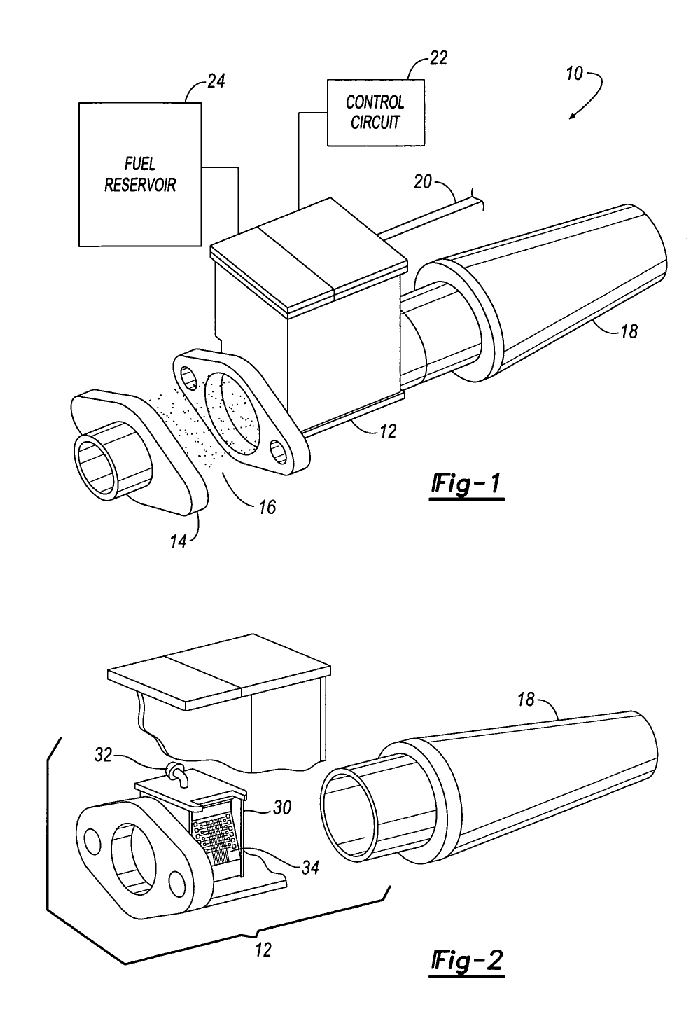

Referring to FIG. 1, an embodiment of a system 10 for generating a combustible vapor from liquid fuel is illustrated. The system 10 includes a fuel injector 12 that is mounted to an intake manifold 14 of a combustion chamber (not shown). The fuel injector 12 generates a combustible vapor 16, which passes through the intake manifold 14 into the combustion chamber. One skilled in the art will recognize that the fuel injector 12 may be mounted in various other ways such that it is able to provide a combustible vapor 16 to the combustion chamber. The combustible vapor 16 may be generated by passing a stream of air through a plurality of fixed quantum drops of liquid fuel in the fuel injector 12. The air stream may be provided to the fuel injector 12 through a conventional air filter 18, and the liquid fuel may be provided to the fuel injector 12 from a conventional fuel reservoir 24, such as an automotive gas tank. The particular air/fuel mixture generated by the fuel injector 12 at any given time is determined in response to and controlled by a control circuit 22 and a throttle 20.

FIG. 2 illustrates the system shown in FIG. 1 with the outer housing of the fuel injector 12 cut away so as to show an exemplary embodiment of a fuel drop ejector 30 for ejecting fixed quantum (same volume or size) drops of liquid fuel. The drop ejector 30 includes a fuel inlet 32, which is in fluid communication with the fuel reservoir 24 (FIG. 1), allowing the drop ejector 30 to receive a continuous supply of liquid fuel. The fuel injector 30 also includes a tape automated bonding (“TAB”) circuit 34, which is electrically connected to control circuit 22. The fuel injector 30 receives electrical control signals from the control circuit 22 through TAB circuit 34 to control the ejection of fuel drops. Other forms of interconnection are known to those skilled in the art and can be substituted for the TAB circuit 29 within the spirit and scope of the invention. Further, though FIG. 2 illustrates only a fuel drop ejector 30 within the fuel injector 12, other components (not shown) may also be included within the fuel injector 12. For example, U.S. patent application Ser. No. 10/086,002 (referenced hereinabove and incorporated herein by reference), having common ownership with this application, describes additional components of an exemplary fuel injector 12 having a drop ejector 30.

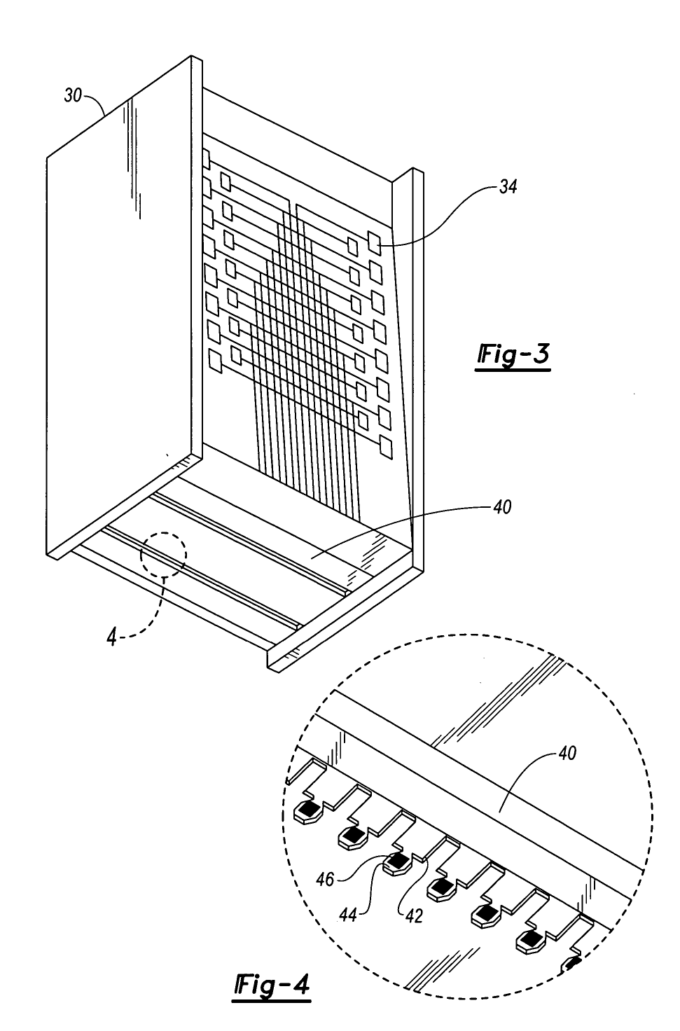

FIG. 3 is a perspective view of the drop ejector 30 shown as part of the fuel injector 12 in FIG. 2. As described in U.S. Pat. No. 6,162,589 (referenced above), an embodiment of the drop ejector 30 generally includes one or more fluid channels 40 (FIG. 3 shows the drop ejector 30 having two distinct fluid channels 40). As shown in FIG. 4, each fluid channel 40 includes one or more branching fluid feed slots 42. Each fluid feed slot 42 is associated with a firing chamber 44. Each firing chamber 44 includes an energy dissipation device 46, such as a resistor or flextentional device, for example. In some embodiments (as shown in FIGS. 4, 5 and 6) energy dissipation device 46 is smaller in size than the outlet orifice 48, which may help to reduce the “puddling” and “bubble trapping” problems described hereinafter. Each fluid feed slot 42 facilitates fluid communication between the fluid channel 40 and the associated firing chamber 44 so that a constant supply of liquid fuel is provided to each firing chamber 44.

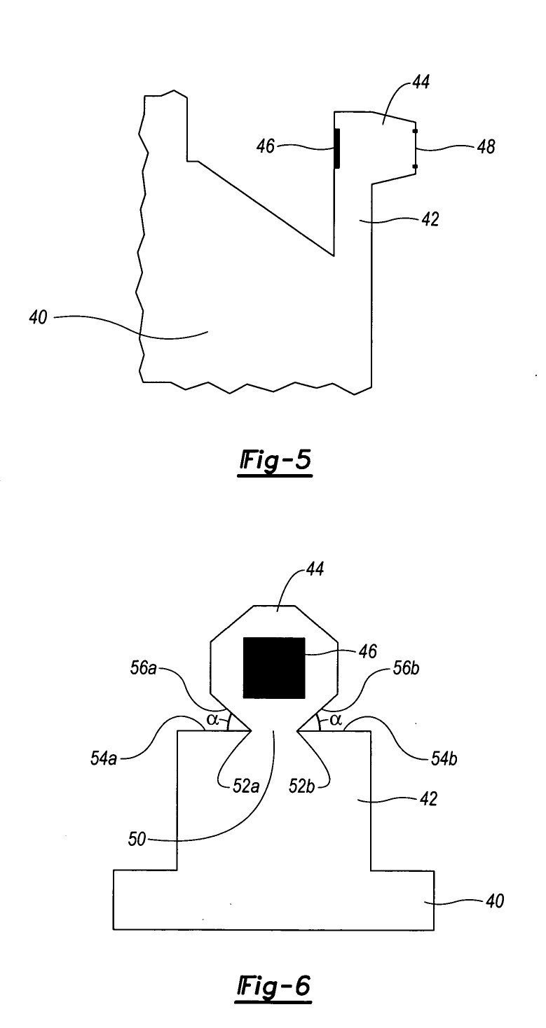

FIG. 5 illustrates a side, cross-sectional view of a single exemplary firing chamber 44, as well as its corresponding energy dissipation device 46 and feed slot 42. FIG. 5 also illustrates the fluid communication between the fluid channel 40 and the firing chamber 44 via fluid feed slot 42. As described in more detail below, fixed quantum drops of liquid fuel are sequentially ejected from the firing chamber 44 through outlet orifice 48.

In response to control signals received from the control circuit 22 (FIG. 1), the energy dissipation devices (FIGS. 4 & 5) are selectively activated, causing the liquid fuel in the corresponding firing chamber to be heated. When the liquid fuel in a given firing chamber 44 is sufficiently heated, the liquid boils, causing a bubble to form. The expanding bubble pushes some of the liquid fuel (in the form of a fixed quantum drop) out of outlet orifice 48.

FIG. 6 shows a top view of the firing chamber 44 illustrated in FIG. 5, wherein like elements have like reference numerals. As illustrated in FIG. 6, a cross section of the firing chamber 44 may have a polygon shape, or, in other embodiments, the firing chamber may be substantially round or have other shapes. The firing chamber 44 has a constricted inlet 50, which allows fluid to flow from the feed slot 42 into the firing chamber 44. The inlet 50 is “constricted” in the sense that it is narrower than the width of both the firing chamber 44 and the corresponding feed slot 42. The constricted inlet may be formed, as shown in FIG. 6, by protruding points 52(a) and 52(b) that oppose each other.

In some embodiments, the protruding points 52(a) and 52(b) are formed by converging surfaces 54(a), 56(a) and 54(b), 56(b), respectively. Surfaces 54(a) and 54(b), located on the feed slot side of the protruding points 52(a) and 52(b), are “flat” in the sense that they are substantially perpendicular to the flow of liquid through the feed slot 42. On the other hand, surfaces 56(a) and 56(b), located on the firing chamber side of the protruding points 52(a) and 52(b), are “angled” in the sense that they create an acute angle a with the respective flat surfaces 54(a) and 54(b), thereby providing an expanded lateral area in the firing chamber for the liquid to fill after it passes through the constricted inlet 50.

In operation (with reference to all of the drawings), the fuel injector 12 creates a combustible vapor 16 by passing an air stream (provided through air filter 18) through a plurality of drops of liquid fuel. The liquid fuel drops are generated by the drop ejector 30 in response to control signals received from control circuit 22. The drop ejector 30 generates and ejects the fuel drops by selectively (in response to the control signals) energizing the energy dissipation devices 46, which causes the liquid fuel in the corresponding firing chambers 44 to bubble in the firing chamber 44. Because of the constricted inlet 50, the bubble also expands through the inlet 50 and at least partially into the feed slot 42. Inside the firing chamber 44, the expanding bubble causes a drop of liquid fuel to be ejected from the outlet orifice 48 of the firing chamber 44. Once the energy dissipation device 46 is de-energized, the expanding bubble collapses. As the bubble collapses, liquid fuel is drawn into the firing chamber 44 from feed slot 42 (due to the surface tension of the fuel) to fill the void left by the collapsing bubble, effectively “re-loading” the firing chamber for the next fuel drop to be ejected.

The described embodiment of the firing chamber 44—and particularly the constricted inlet 50 to the firing chamber 44 defined by the two protruding points 52(a) and 52(b)—tends to prevent “puddling” and “bubble trapping” problems that could otherwise occur as a result of the relatively low surface tension (relatively low viscosity) of liquid fuels. “Puddling” occurs when excess fuel adheres to and around the outlet orifice 48, thereby causing subsequent fuel drops to have to be ejected through the excess “puddling” fuel. The “puddling” affects the trajectory of subsequent fuel drops, and, sometimes, prevents subsequent drops of fuel from being ejected at all. The constricted inlet 50 tends to eliminate “puddling” because the constricted inlet reduces the momentum of fuel rushing into the firing chamber 44 by restricting the fluid flow therethrough. Further, the constricted inlet 50 limits the degree to which an expanding liquid bubble (due to an activated energy dissipation device 46) can expand into the feed slot 42. In embodiments having flat surfaces 54(a) and 54(b), the flat surfaces provide resistance to the liquid flow, and, as a result, assist in limiting the expanding liquid bubble from expanding into the feed slot 42 more than a desired amount. Therefore, most of the bubble expansion in the firing chamber 44 occurs toward the outlet orifice 48, thereby maintaining a relatively higher drop speed (the speed at which a drop is ejected from the drop ejector). Maintaining an adequately high drop speed from the drop ejector helps to prevent or limit “puddling.”

“Bubble trapping” occurs when an insufficient amount of liquid fuel “refills” the firing chamber 44 quickly enough after a drop of fuel is ejected from the firing chamber. The in-rushing fuel cools the energy dissipation device 46 after being energized to eject a drop of fuel. If the in-rushing fuel does not sufficiently cool the energy dissipation device 46 quickly enough, the energy dissipation device 46 may cause a bubble to form in the feed slot 42, which may block the inlet 50 and prevent additional fuel from being drawn into the firing chamber 44. Without fuel in the firing chamber, the material (normally silicon) surrounding the blocked firing chamber may overheat, causing short circuits in the drop ejector. The constricted inlet 50 prevents “bubble trapping” problems by ensuring that sufficient liquid fuel “refills” the firing chamber 44 quickly enough after a drop of fuel is ejected. The constricted inlet 50 causes the bubble that forms in the firing chamber 44 to extend through the constricted inlet 50 and into the feed slot 42 so as to draw sufficient fuel from the feed slot 42 into the firing chamber 44 when the bubble collapses. In embodiments having angled surfaces 56(a) and 56(b), the angled surfaces help to increase the velocity of the liquid filling the firing chamber by reducing the resistance to the liquid flow. Thus, the angled surfaces 56(a) and 56(b) increase the speed with which the firing chamber 44 can be refilled for a given opening size of the inlet 50.

“Puddling” and “bubble trapping” problems can be limited by controlling the refill speed of the firing chamber 44 and the drop speed of the liquid fuel being ejected from the drop ejector. The refill speed and the drop speed can be effectively controlled by adjusting the size of the inlet 50 and the size of the angle a between the angled surfaces 56(a) and 56(b) and the respective flat surfaces 54(a) and 54(b).

While the present invention has been particularly shown and described with reference to the foregoing preferred and alternative embodiments, those skilled in the art will understand that many variations may be made therein without departing from the spirit and scope of the invention as defined in the following claims. For example, an embodiment of a drop ejector having a constricted inlet was described above in connection with a fuel injector apparatus. However, one skilled in the art will recognize, in light of this disclosure, that the described drop ejector may be used in a variety of settings where liquids of relatively low viscosity are to be dispensed in discrete drops in a digital fashion. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements. Further, the use of the words “first”, “second”, and the like do not alone imply any temporal order to the elements identified. The invention is limited by the following claims.

1. A drop ejector for ejecting discrete drops of liquid, comprising:
a plurality of firing chambers, each firing chamber having an energy dissipation device;
each firing chamber being associated with a fluid feed slot configured to supply liquid fuel to said firing chamber; and
a constricted inlet positioned between said firing chamber and said fluid feed slot, through which liquid is drawn into said firing chamber from said fluid feed slot.

2. The drop ejector of claim 1, wherein:
each firing chamber includes an outlet orifice; and
said energy dissipation device is smaller in size than said outlet orifice.

3. The drop ejector of claim 1, wherein said constricted inlet is defined by two protruding points that oppose each other.

4. The drop ejector of claim 3, wherein each protruding point is defined by a flat surface, said flat surface being substantially perpendicular to the flow of liquid fuel in said fluid feed slot, and an angled surface in said firing chamber, said flat surface and said angled surface establishing an acute angle therebetween.

5. The drop ejector of claim 1, wherein a width of said constricted inlet is smaller than a width of said firing chamber and,a width of said fluid feed slot.

6. The drop ejector of claim 1, wherein said energy dissipation device is a resistor.

7. The drop ejector of claim 1, wherein said liquid is liquid fuel.

8. An apparatus for generating a combustible vapor, comprising:
a drop ejector configured to eject discrete drops of liquid fuel into an air stream, wherein said drop ejector includes:
a plurality of firing chambers, each firing chamber having an energy dissipation device;
each firing chamber being associated with a fluid feed slot configured to supply liquid fuel to said firing chamber; and
a constricted inlet located between said firing chamber and said fluid feed slot, through which liquid fuel is drawn into said firing chamber from said fluid feed slot.

9. The apparatus of claim 8, wherein said constricted inlet is defined by two protruding points that oppose each other.

10. The apparatus of claim 9, wherein each protruding point is defined by a flat surface, said flat surface being substantially perpendicular to the flow of liquid fuel in said feed slot, and an angled surface in said firing chamber, said flat surface and said angled surface establishing an acute angle therebetween.

11. The apparatus of claim 9, wherein a width of said constricted inlet is smaller than a width of said firing chamber and a width of said fuel feed slot.

12. The apparatus of claim 9, wherein said energy dissipation device is a resistor.

13. A method of generating a combustible vapor, comprising:
passing a plurality of discrete drops of liquid fuel through an air stream;
wherein each of said drops of liquid fuel is generated by heating liquid fuel in a firing chamber such that a bubble of liquid fuel forces a drop of liquid fuel to be ejected from said firing chamber through an outlet orifice, and wherein liquid fuel is drawn into said firing chamber through a constricted inlet as a result of said bubble of liquid fuel collapsing.

14. The method of claim 13, wherein said constricted inlet is defined by two protruding points that oppose each other.

15. The method of claim 14, wherein each protruding point is defined by a flat surface, said flat surface being substantially perpendicular to the flow of liquid fuel in a fluid feed slot, and an angled surface in said firing chamber, said flat surface and said angled surface establishing an acute angle therebetween.

16. The method of claim 13, wherein a width of said constricted inlet is smaller than a width of said firing chamber and a width of said fluid feed slot.

17. A drop ejector for ejecting discrete drops of liquid, comprising:
a means for ejecting discrete drops of liquid from an outlet orifice;
a means for delivering said liquid to said means for ejecting; and
a constricted inlet positioned between said means for ejecting and said means for delivering liquid, through which said liquid is delivered to said means for ejecting from said means for delivering liquid.

18. The drop ejector of claim 17, wherein
said means for ejecting includes a plurality of firing chambers, each firing chamber having an outlet orifice; and
said energy dissipation device is smaller in size than said outlet orifice.

19. The drop ejector of claim 17, wherein said constricted inlet is defined by two protruding points that oppose each other.

20. The drop ejector of claim 19, wherein each protruding point is defined by a flat surface, said flat surface being substantially perpendicular to the flow of liquid fuel in said fluid feed slot, and an angled surface in said firing chamber, said flat surface and said angled surface establishing an acute angle therebetween.
